(19) United States
(12) Patent Application Publication
(10) Pub. No.: US 2005/0143087 A1
(43) Pub. Date: Jun. 30, 2005

(54) Dynamic selection of a packet data serving node

(75) Inventors: Samy Touati, Rosemere (CA); Lila Madour, Kirkland (CA); Mahmood Hossain, Pointe Claire (CA)

Correspondence Address: SANDRA BEAUCHESNE;Ericsson Canada Inc ., Patent Department (LMC/M/P), 8400 Decarie Blvd., Town Mount Royal, QC, H4P 2N2, CA

(73) Assignee: Telefonaktiebolaget L M Ericsson (publ)

(21) Appl. No.: 10/745,506

(22) Filed: Dec. 29, 2003

(51) Int. Cl. H04Q 7/20

(52) U.S. Cl. 455/453

(57) ABSTRACT

The invention relates to a method for supporting load balancing in a packet data network. The method receives a registration request at a packet data serving node (PDSN) manager from a base station controller/packet core function (BSC/PCF), The registration request includes a vendor specific extension (VSE) for indicating to the PDSN manager that the BSC/PCF supports redirection of the registration request and an international mobile subscriber identity (IMSI) of a mobile terminal (MT) for determining that a session does not presently exist between a mobile terminal (MT) associated with the IMSI and a PDSN agent associated with the PDSN manager. The invention also relates to a base station controller/packet core function (BSC/PCF) for creating a list of available packet data serving node (PDSN) agents.

### BACKGROUND OF THE INVENTION

1. Field of the invention

The invention relates to a method for performing dynamic load balancing in a 3^{rd} Generation (3G) mobile telecommunications network.

2. Description of the Related Art

CDMA2000 cellular telecommunications network is a third generation (3G) cellular telecommunications network that provides IP connectivity to mobile terminals (MTs).

A CDMA2000 packet switched core network comprises, at least logically, a Home Agent (HA), a Foreign Agent (FA), a Packet Data Serving Node (PDSN), a Packet Core Function (PCF) usually co-located with a Base Station Controller (BSC), and an Authentication, Authorization and Accounting Server (AAA). The HA provides mobile IP services and keeps track of the MTs association with the network, among other things acting like a router when a MT roams in another network, receiving packets intended for the MT and tunneling them towards the MT, via the FA in the network where the MT is located. The PDSN acts as a gatekeeper, deciding which MTs are allowed to use services and access the network, while the BSC, among other things, establishes the traffic channel for the MT, and the PCF decides which PDSN to send the traffic through.

It is advantageous to allow for load sharing between PDSNs so that, for example, one particular PDSN is not overloaded while other PDSNs are nearly idle, if possible. A state of the art solution for providing load balancing among PDSNs is shown in FIG. 1. The telecommunications network 110 comprises a co-located Base Station Controller/Packet Core Function (BSC/PCF) 112 and a PDSN 113. An MT 11 is physically located within the service area of the network 110, but is not yet served by the network 110. The MT 11 is identified with—a unique identity—an International Mobile Subscriber Identity (IMSI).

It should be understood that the structure, or architecture, of a PDSN may vary considerably as its internal functioning is not defined in any standard. In the present example, it is assumed that the PDSN 113 comprises a manager 114 and a plurality of agents of which only one, agent A 115, is shown. The division of a PDSN into manager and agent can be physical, logical or physical and logical. The manager 114 supervises the agents, keeps track of the sessions associated with each agent, collects information about the load of each agent, performs load balancing, if appropriate, and so on. The agents, among other things, handle user data and accounting, provide load information to the manager 114, and maintain the Point-to-Point Protocol (PPP) state machines that originates at MT 11 and terminates at the agent A 115. It is preferred, but not necessary, to co-locate the manager and the agents.

The MT 11 sends an origination message 20 to the BSC/PCF 112 to request packet data service. The origination message includes the IMSI 120 of the MT 11.The BSC/PCF 112 may assign a traffic channel 13 to the MT 11 prior to, or in parallel with, the messages described below. The BSC/PCF 112 performs a PDSN selection, step 12, as is well known in the art, by hashing the IMSI 120 of the MT 11, and then using modulo—(number of possible PDSNs) arithmetic on the result to decide which PDSN to use from a list of PDSN IP addresses which consist of IP addresses of PDSN managers similar to manager 114. Thus, unless the list of possible PDSNs changes, the BSC/PCF 112 will always choose the same PDSN for a given IMSI. In this exemplary scenario, the BSC/PCF 112 chooses the PDSN 113 and sends it a Registration Request 121, comprising the IMSI 120 of the MT 11.

At the PDSN 113, the manager 114 receives the Registration Request 121, and selects which agent to use, step 14. The manager 114 keeps a list of active sessions corresponding to the IMSIs, and uses the list to determine if there already exists an active session for the IMSI and if this is the case, chooses the agent associated with the session. If there is no active session for the IMSI, then the manager 114 chooses an agent according to some predetermined scheme, such as for example the agent with the least load. As previously mentioned, the manager 114 is aware of the load on each agent to which it can directly forward Registration Requests.

When the manager 114 has decided which agent should handle the connection, it returns to the BSC/PCF 112 a Registration Reply 122 comprising the code ‘136’, indicating that it returns an alternative PDSN IP address, and the alternative address itself, i.e. the IP address of the selected PDSN entity, which in the present case is the PDSN agent A 115 (IP address 116). Note that the BSC/PCF 112 has no way of knowing whether the new IP address is associated with an entity co-located with the manager 114 or not; thus the BSC/PCF 112 treats the IP address as belonging to a second PDSN.

Upon reception of the Registration Reply 122, the BSC/PCF 112 retrieves code ‘136’ and the alternative IP address. The BSC/PCF 112 has a common security association with the manager 114 and the agents that the manager 114 can use, and uses the security association to compute an authentication extension for mutual authentication of BSC/PCF 112 and agent A 115 that it includes in a second Registration Request 123 that is sent to agent A 115. Agent A 115 validates the Registration Request 123 upon reception and, if the request 123 is validated, replies with a second Registration Reply 124. When the second Reply 124 has been received, the MN 11 and agent A 115 negotiate a Point-to-Point Protocol (PPP) session 25.

The only standardized way to provide load balancing in a reasonably efficient way is to make use of error code ‘136’, as described above. However, considering that this has to happen every time a new MT registers with the CDMA2000 network 110 with distributed cluster architecture comprising a PDSN manager and its associated PDSN agents like PDSN 113, it is still an inefficient way to do it, that imposes unnecessary signaling load and set up delay on the nodes and the network.

It is also more or less inevitable with this solution that the PCFs needs to be configured with all the addresses of the PDSN agents, and their relationships to the PDSN managers. This causes unnecessary workload on the carrier (configuration of PCFs) and it increases the risk for faults due to misconfiguration, e.g. when increasing the capacity of a PDSN by adding agent boards or when moving an agent board from one PDSN to another.

It is therefore desirable to find a solution that is more efficient, more flexible and easier to manage. The present invention provides such a solution.

### SUMMARY OF THE INVENTION

It is therefore one broad object of this invention to provide a method for supporting load balancing in a packet data network, the method comprising steps of:
receiving at a packet data serving node (PDSN) manager from a base station controller/packet core function (BSC/PCF) a registration request including:
i) a vendor specific extension (VSE) for indicating that the BSC/PCF supports redirection of the registration request; and
ii) an international mobile subscriber identity (IMSI) of a mobile terminal (MT);
using the IMSI, at the PDSN manager for determining that a session does not presently exist between a mobile terminal (MT) associated with the IMSI and a PDSN agent associated with the PDSN manager;
using the VSE, at the PDSN manager for determining that the BSC/PCF supports redirection of the registration request;
selecting at the manager a PDSN agent from a plurality of PDSN agents for handling a new packet data session to the MT; and
redirecting the registration request from the PDSN manager to the selected PDSN agent.

It is therefore another broad object of his invention to provide a packet data serving node (PDSN) comprising:
a PDSN manager;
at least one PDSN agent;
wherein the PDSN manager receives from a base station controller/packet core function (BSC/PCF) a registration request including a vendor specific extension (VSE) for indicating that the BSC/PCF supports redirection and an international mobile subscriber identity (IMSI) of a mobile terminal (MT); wherein the PDSN manager further:
   uses the IMSI for determining that a session does not presently exist between a mobile terminal (MT) associated with the IMSI and a PDSN agent associated with the PDSN manager;
   uses the VSE for determining that the BSC/PCF supports redirection of the registration request;
   selects a PDSN agent from a plurality of PDSN agents for handling a new packet data session to the MT; and
   redirects the registration request from the PDSN manager to the selected PDSN agent.

It is therefore another broad object of his invention to provide a base station controller/packet core function (BSC/PCF) for creating a list of available packet data serving node (PDSN) agents, wherein the BSC/PCF:
sends a registration request to a PDSN manager associated to at least one of the PDSN agents, wherein the registration request includes:
   i) a vendor specific extension (VSE) for indicating that the BSC/PCF supports redirection
   ii) an international mobile subscriber identity (IMSI) of a mobile terminal (MT).

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a nodal operation and signal flow diagram illustrating a flow of messages of prior art load balancing in a telecommunications network;

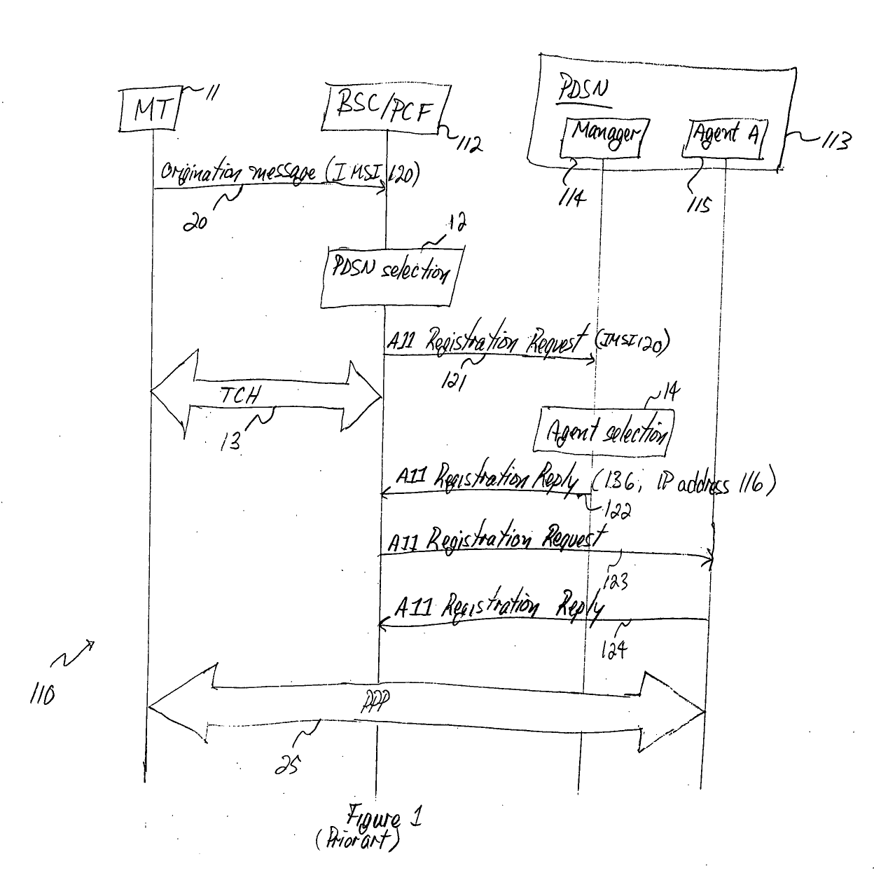

FIG. 2 is a nodal operation and signal flow diagram illustrating a flow of messages of a load balancing method in accordance to the invention; and

FIG. 3 is a flow chart showing a method for creating a list of IP addresses of Packet Data Serving Node (PDSN) agents in a BSC/PCF in accordance to the invention.

### DETAILED DESCRIPTION OF THE PREFERRED EMBODIMENTS

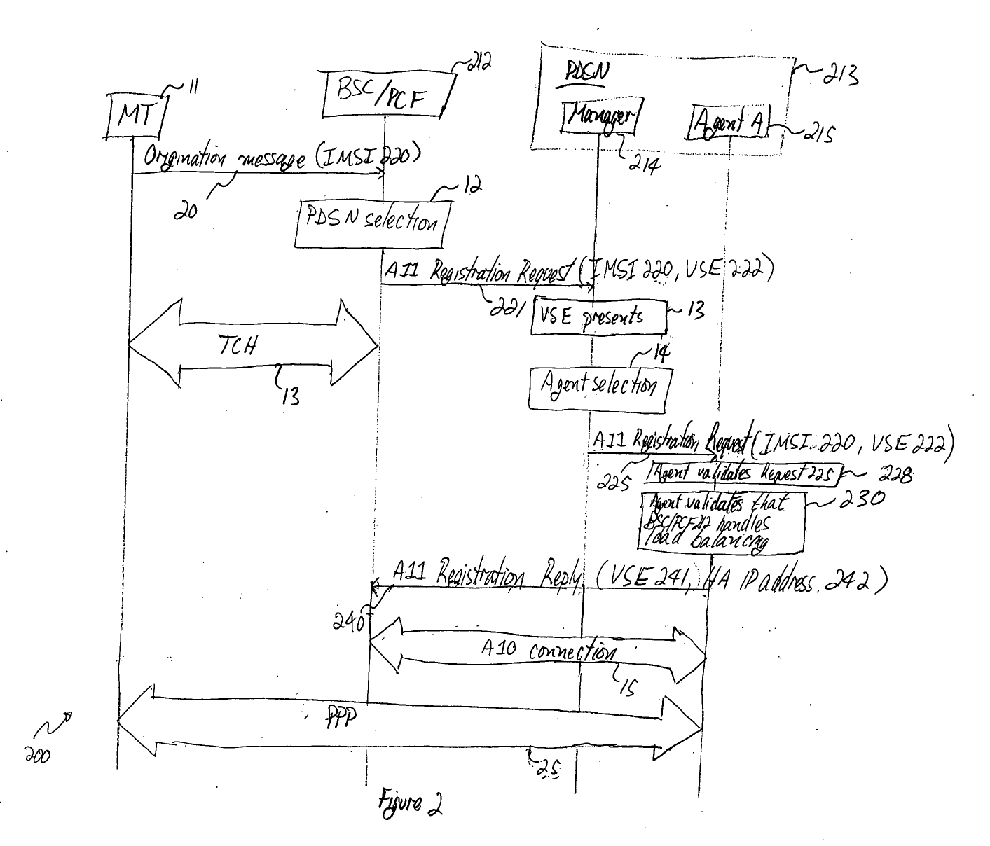

Reference is now made to FIG. 2, which illustrates a nodal operation and signal flow diagram illustrating a flow of messages of a load balancing method in a telecommunications network 200 in accordance to the invention. The telecommunications network 200 is described as a CDMA2000 network, but can be any packet data network such as a 3G network using Mobile IP signalling and having a distributed mobility agent cluster. For that reason, it can be understood that any 3G network such as any Global System Mobile/Universal Mobile Telecommunication System (GSM/UMTS) network with IP mobility solution using Mobile IP signaling could have been used instead of the CDMA2000 network. The network 200 comprises a co-located Base Station Controller/Packet Core Function (BSC/PCF) 212 and a Packet Data Serving Node (PDSN) 213. A mobile terminal (MT) 11 is physically located within the service area of the network 200, but is not yet served by the network 200. The MT 11 is identified with—a unique identity—an International Mobile Subscriber Identity (IMSI).

The PDSN 213 comprises a manager 214 and a number of agents of which only agent A 215 is shown for clarity. In the PDSN 213, the manager 214 and agent A 215 are co-located, but it should be understood that agent A 215 may be located in another physical node, that may or may not also comprise a second manager (not shown). The manager 214 supervises the agents, keeps track of the sessions associated with each agent, collects information about the load of each agent, performs load balancing, if appropriate, and so on. The manager 214 performs load balancing in spreading tasks among agents in a way to avoid some agents being idle while others have tasks queuing for execution.

The agents, among other things, handle user data and accounting, provide load information to the manager 214, and maintain the Point-to-Point Protocol (PPP) state machines that originates at MT 11 and terminates at the agent A 215. It is preferred, but not necessary, to co-locate the manager and the agents.

In FIG. 2, the MT 11 sends an origination message 20 to the BSC/PCF 212 to request packet data service. The origination message includes the IMSI 220 of the MT 11. The BSC/PCF 112 may assign a traffic channel 13 to the MT 11 prior to, or in parallel with, the messages described below. The BSC/PCF 212 performs a PDSN selection, step 12 as is well known in the art, by hashing the IMSI 220 of the MT 11, and then using modulo—(number of possible PDSNs) arithmetic on the result to decide which PDSN to use from a list of PDSN IP addresses which consist of IP addresses of PDSN managers similar as manager 214. Thus, unless the list of possible PDSNs changes, the BSC/PCF 212 will always choose the same PDSN for a given IMSI. In this exemplary scenario, the BSC/PCF 212 chooses the PDSN 213 and sends to an All Registration Request 221 to the PDSN 213.

The BSC/PCF 112 has a common security association with the manager 114 and the agents that the manager 114 can use. The BSC/PCF 212 uses the security association to compute an authentication extension for mutual authentication of the BSC/PCF 112 and the agent 215. The Registration Request 221 comprises the IMSI 220 of the MT 11. Furthermore, the BSC/PCF 212 indicates in the Registration Request 221 sent to the PDSN manager 214 that it can handle a Reply from a different PDSN IP address, or that it supports re-direction performed to another PDSN. In particular, the PDSN manager 214 and the PDSN agent 215 are considered as two different PDSNs in which both are identified by an IP address. For that reason, the Registration Request 221 also comprises a Vendor Specific Extension (VSE) 222. The VSE 222 indicates that the BSC/PCF 212 and PDSN 213 support re-direction of Registration Requests for MTs. When re-direction is used for the purpose of optimized load balancing, this VSE 222 is included in both the Registration Request and Reply messages. At step 13, if the PDSN manager 214 that supports re-direction receives a Registration Request that does not contain a VSE, it does not re-direct the request to an agent. Instead, it uses the standard procedure described in the prior art to perform load balancing, i.e. sends a reply with code ‘136’ and the “HA IP address” element set to an alternative PDSN agent IP address. However, at step 14, if a VSE is present in the Registration Request 221, the manager 214 selects a PDSN agent during the PDSN agent selection procedure. As well, PDSNs that do not support re-direction do not discard a Registration Request because it includes a VSE.

The manager 214 receives the Request 221 and determines from the IMSI 220 if a packet data session already exists with one of its agents. If so, the manager 214 redirects the Registration Request 221 to the agent with which it has a packet data session involved. Othervise, if a packet data session does not exist with one of its agents, the manager 214 determines from the VSE 222 that is included in the Registration Request 221 that the BSC/PCF 212 can handle replies from a different PDSN IP address or that Registration Request message re-direction is supported. Following this, the manager 214 may select a least loaded PDSN agent (agent A 215) for handling a packet data session for the MT 11 and redirects the A11 Registration Request 221 in an A11 Registration Request 225 to the agent 215. The A11 Registration Request 221 and the A11 Registration Request 225 also comprise information elements as described in table 1. The selection of the PDSN agent 215 is based on selecting at the PDSN manager 214 a least loaded PDSN agent. However, it can be understood that a PDSN agent such as PDSN agent 215 can be selected in a different manner such as based on a round robin manner. More precisely, the invention is not only limited to a PDSN agent selection based on the load of a PDSN agent.

TABLE 1

| Information Element | Type |
|---|---|
| A11 Message Type | M |

| | | |
|---|---|---|
| Flags | O | R |
| Lifetime | O | R |
| Home Address | O | R |
| Home Agent | O | R |
| Care-of-Address | O | R |
| Identification | O | R |
| Session Specific Extension | O | R |
| Critical Vendor/Organization | O | C |
| Specific Extension(s) | | |
| Mobile-Home Authentication | O | R |
| Extension | | |
| Normal Vendor/Organization | O | C |
| Specific Extension | | |
| Normal vendor specific extension | O | C |
| (VSE) | | |

M: Information elements that are mandatory for the message.
O: Information elements that are optional for the message.
R: Required in the message whenever the message is sent.
C: Conditionally required. The conditions for inclusion of this element are defined in the operation(s) where the message is used.

The agent 215 receives the Registration Request 225 from the manager 214. Following this, the agent 215 determines from the VSE 222 that the originating BSC/PCF 212 handles optimized load balancing, at step 230. The optimized load balancing is based on the same PDSN agent selection as described in the art, but instead of returning an error code 136 to the PCF, the PDSN manager 214 forwards directly or re-directs the A11 Registration Request (connection setup) to the selected PDSN agent 215 and the PDSN agent 215 replies directly to the BSC/PCF 212. For doing so, the agent 215 validates the Request 225 (step 228) and sends an A11 Registration Reply 240 to the BSC/PCF 212 in response to the Registration Request 221. The Registration Reply 240 includes a VSE 241 in the Registration Reply 240 for indicating to the BSC/PCF 212: “re-direction performed”. The Registration Reply 240 also includes a “Home Agent IP address” element (HA IP address 242). The A11 Registration Reply 240 also comprises information elements as described in table 2.

TABLE 2

| Information Element | Type |
|---|---|
| A11 Message Type | M |
| Code | M |
| Lifetime | M |
| Home Address | M |
| Home Agent | M^{a} |
| Identification | M |
| Session Specific Extension | M |

| | | |
|---|---|---|
| Critical Vendor/Organization | O | C |
| Specific Extension | | |
| Mobile-Home Authentication | O | R |
| Extension | | |
| Normal Vendor/Organization | O | C |
| Specific Extension | | |
| Normal vendor specific extension | O^{b} | C |

^{a}In presence of the VSE 222 in the Request 225, this element (Home Agent IP address) is used to contain the IPv4 address of the PDSN agent 215 (IP address of the agent) that replies directly to the redirected Request 225 that was redirected from the manager 214.
^{b}This element shall be included as a result of a redirected Request 225 from the manager 214. The Request 225 must contain the same information element.

Following this, the agent 215 sets the “HA IP address” field 242 to its own IP address and includes, within the Reply 240, an authentication extension (not shown) required between the BSC/PCF 212 and the agent 215. The Reply 240 is sent directly to the BSC/PCF 212. The VSE 222 is used by the BSC/PCF 212 to determine that the Reply 240 is coming from an alternative PDSN IP address that supports optimized load balancing. The BSC/PCF 212 shall use the same security association it has with the manager 214 to compute the same authentication extension as performed by the agent 215. The BSC/PCF 212 sets-up an A10 connection (step 15) with the agent 215 and forwards subsequent Registration Requests from the MT 11 directly to the agent 215. Afterwards, a PPP session is negotiated between the agent 215 and the MT 11 (step 25).

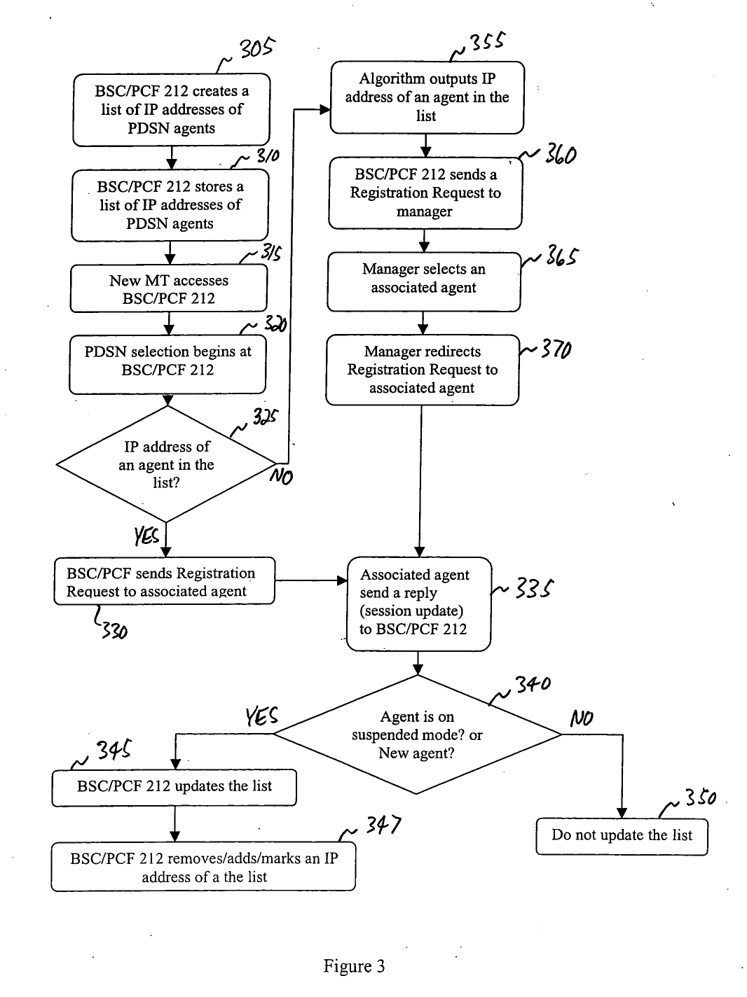

Reference is now made concurrently to FIG. 3, which illustrates a flow chart of a method for creating a list of IP addresses of PDSN agents in the BSC/PCF 212 in accordance to the invention. Following the reception of the Registration Reply message 240, the BSC/PCF 212 creates (step 305) and stores (step 310) a list of available agents identified by the IP address of PDSN agents and updates the list based on the responses similar to the A11 Registration Reply 240 received from agents. For example, the BSC/PCF 212 stores in the list the “HA IP address” field (e.g. HA IP address 242), which has been for example set to the IP address of the PDSN agent 215 and which has been received in the Registration Reply 240.

At step 315, this list is used following an origination message for a new access made by a MT different than MT 11. The list is used during a PDSN selection operation such as the PDSN selection of step 12 (step 320). At step 325, if a selection algorithm outputs an IP address of an agent in the list, the BSC/PCF 212 sends a Registration Request similar as the Registration Request 221 to the selected agent. Following this, the BSC/PCF 212 directly sends the Registration request to the selected agent (step 330). The agent then sends a Registration Reply to the BSC/PCF 212 for responding to the Registration Request replies and for informing the BSC/PCF 212 about its status (step 335).

However if at step 325, the selection algorithm does not returns the IP address of an agent it means that it is an IP address of a manager. If so, at step 355, the BSC/PCF 212 sends a Registration Request for the MT to the selected manager (step 360). Next, the manager selects an agent (step 365) and redirects the Registration Request to the agent (step 370) The agent then sends a Registration Reply to the BSC/PCF 212 for responding to the Registration Request replies and for informing the BSC/PCF 212 about its status (step 335).

As a consequence, the list can be updated, at step 345, whenever a Registration Reply or a session update is sent from an agent similar to the agent 215 to the BSC/PCF 212. If the agent is not a new agent (new entry in the list) or if the agent is not on suspended mode, the BSC/PCF does not update the list (step 350). Alternatively, once any MT no longer uses an agent, the BSC/PCF 212 updates the list by removing the IP address of this agent (HA IP address) from the list. More precisely, the BSC/PCF 212 may remove some entries of agents' IP addresses if no active connections use them for some period of time (step 347). It can be necessary for the BSC/PCF 212 to remove an IP address of an agent because its load status of has changed and/or because no MT has an active connection with the agent.

Alternatively, an agent such as agent 215 can be on suspended mode (step 340) for any reason such as when it hits a high load of data. As a consequence, when the agent 215 is on suspended mode, the BSC/PCF 212 keeps the IP address of the agent 215 in the list, but marks it as unusable. This agent 215 may further send a session update (step 335) to the BSC/PCF 212 to indicate if it should be suspended from any future new access. However, the agent 215 continues to handle existing sessions with MTs. The only way for the BSC/PCF 212 to reselect this agent is to send a Registration Request to a manager that is associated with the agent. The manager 214 then forwards the Registration Request to the agent who later sends a session update for updating its status toward the BSC/PCF 212. Alternatively, when the agent is ready to handle new sessions, it sends a new session update (step 335) to the BSC/PCF 212 to resume its active status in the list.

Although several preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for supporting load balancing in a packet data network, the method comprising steps of:
receiving at a packet data serving node (PDSN) manager from a base station controller/packet core function (BSC/PCF) a registration request including:
iii) a vendor specific extension (VSE) for indicating that the BSC/PCF supports redirection of the registration request; and
iv) an international mobile subscriber identity (IMSI) of a mobile terminal (MT);
using the IMSI, at the PDSN manager for determining that a session does not presently exist between a mobile terminal (MT) associated with the IMSI and a PDSN agent associated with the PDSN manager;
using the VSE, at the PDSN manager for determining that the BSC/PCF supports redirection of the registration request;
selecting at the PDSN manager a PDSN agent from a plurality of PDSN agents for handling a new packet data session to the MT; and
redirecting the registration request from the PDSN manager to the selected PDSN agent.

2. The method for supporting load balancing of claim 1, wherein the step of selecting further includes a step of selecting at the PDSN manager a least loaded PDSN agent from a plurality of PDSN agents.

3. The method for supporting load balancing of claim 1, the method further comprises steps of:
using the VSE, at the PDSN agent for determining that the BSC/PCF handles optimized load balancing;
validating at the PDSN agent the registration request received from the PDSN manager; and
sending from the PDSN agent to the BSC/PCF a registration reply for indicating that a redirection of the registration request has been performed, the registration reply including an IP address of the PDSN agent.

4. The method for supporting load balancing of claim 3, wherein the step of sending the registration reply further includes a step of setting at the PDSN agent a home agent (HA) IP address field of the registration reply to the IP address of the selected PDSN agent.

5. The method for supporting load balancing of claim 1, the method further comprises steps of:
setting a connection between the BSC/PCF and the PDSN agent;
forwarding from the BSC/PCF to the PDSN agent subsequent registration requests related to the MT; and
negotiating a PPP session between the PDSN agent and the MT.

6. The method for supporting load balancing of claim 4, wherein the step of setting further includes steps of:
receiving the registration reply at the BSC/PCF; and
creating at the BSC/PCF a list of available PDSN agents, wherein each of the PDSN agent is identified by an IP address;
storing the list of available PDSN agents at the BSC/PCF; and
updating at the BSC/PCF the list of available PDSN agents upon receiving a session update from a PDSN agent.

7. The method for supporting load balancing of claim 6, wherein the step of updating further includes a step of removing on IP addresses of a PDSN agent if no active connections with the PDSN agent is used for a certain period of time.

8. The method for supporting load balancing of claim 6, wherein the step of updating further includes steps of:
sending a session update from the PDSN agent for indicating the PDSN agent is on suspended mode;
adding from the list the IP address of a PDSN agent; and
marking in the list at the BSC/PCF that the PDSN agent is on suspended mode.

9. The method for supporting load balancing of claim 6, wherein the step of updating further includes steps of:
sending a session update from the PDSN agent for indicating the PDSN agent is on suspended mode; and
removing from the list an IP address of the PDSN agent.

10. A packet data serving node (PDSN) comprising:
a PDSN manager;
at least one PDSN agent;
wherein the PDSN manager receives from a base station controller/packet core function (BSC/PCF) a registration request including a vendor specific extension (VSE) for indicating that the BSC/PCF supports redirection and an international mobile subscriber identity (IMSI) of a mobile terminal (MT); wherein the PDSN manager further:
uses the IMSI for determining that a session does not presently exist between a mobile terminal (MT) associated with the IMSI and a PDSN agent associated with the PDSN manager;
uses the VSE for determining that the BSC/PCF supports redirection of the registration request;
selects a PDSN agent from a plurality of PDSN agents for handling a new packet data session to the MT; and
redirects the registration request from the PDSN manager to the selected PDSN agent.

11. The PDSN of claim 10, wherein the PDSN agent:
uses the VSE for determining that the BSC/PCF handles optimized load balancing;
validates the registration request received from the PDSN manager; and
sends to the BSC/PCF a registration reply for indicating that a redirection has been performed, the registration reply including an IP address of the PDSN agent.

12. The PDSN of claim 10, wherein the PDSN agent further sends a session update from the PDSN agent for indicating the PDSN agent is on suspended mode.

13. The PDSN of claim 10, wherein the PDSN agent further sets a connection between the BSC/PCF and the PDSN agent.

14. The PDSN of claim 10, wherein the PDSN agent further negotiates a PPP session between the PDSN agent and the MT.

15. A base station controller/packet core function (BSC/PCF) for creating a list of available packet data serving node (PDSN) agents, wherein the BSC/PCF:
sends a registration request to a PDSN manager associated to at least one of the PDSN agents, wherein the registration request includes:
i) a vendor specific extension (VSE) for indicating that the BSC/PCF supports redirection
ii) an international mobile subscriber identity (IMSI) of a mobile terminal (MT).

16. The BSC/PCF of claim 15, the BSC/PCF further:
receives a registration reply from the at least on PDSN agents;
stores the list of available PDSN agents at the BSC/PCF; and
updates at the BSC/PCF the list of available PDSN agents.

17. The BSC/PCF of claim 15, wherein the BSC/PCF removes IP addresses of PDSN agents if no active connections are using them for period of time.

18. The BSC/PCF of claim 15, wherein the BSC/PCF further:
receives a session update from the PDSN agent for indicating the PDSN agent is on suspended mode;
adds from the list the IP address of an PDSN agent; and
marks in the list that the PDSN agent is on suspended mode.

19. The BSC/PCF of claim 15, wherein the BSC/PCF further:
receives a session update from the PDSN agent for indicating the agent is on suspended mode; and
marks in the list that the PDSN agent is on suspended mode.

20. The BSC/PCF of claim 15, wherein the BSC/PCF further removes from the list an IP address of the agent.

21. The BSC/PCF of claim 15, wherein the BSC/PCF further:
sets a connection between the BSC/PCF and the PDSN agent;
forwards subsequent registration requests the PDSN agent; and
negotiates a PPP session between the PDSN agent and the MT.
